(19) United States
(12) Patent Application Publication
(10) Pub. No.: US 2014/0345398 A1
(43) Pub. Date: Nov. 27, 2014

(54) SYSTEM AND METHOD FOR LOWERING A PANTOGRAPH

(71) Applicant: Transtech of South Carolina, Piedmont, SC (US)

(72) Inventors: Douglas A. Robertson, Piedmont, SC (US); Stacy Neil Smith, Piedmont, SC (US)

(21) Appl. No.: 13/898,563

(22) Filed: May 21, 2013

(51) Int. Cl. B60L 5/00

(52) U.S. Cl. CPC B60L 5/00
USPC 74/25

(57) ABSTRACT

A system and method for lowering a pantograph includes a frame that may be extended or retracted. The system and method may include various structure for retracting the frame and for increasing a rate at which the frame is retracted. In particular embodiments, an electric, pneumatic, or hydraulic motor may be used to retract the frame during normal operations, and a continuity circuit operably connected to the motor may accelerate the rate at which the motor retracts the frame.

### FIELD OF THE INVENTION

The present invention generally involves a system and method for lowering a pantograph. In particular embodiments, the pantograph may be incorporated into a rail car to communicate electricity from overhead power lines to the rail car.

### BACKGROUND OF THE INVENTION

Electricity is commonly used to power rail cars travelling over a rail system. Pantographs attached to the rail cars may alternately extend and retract current collectors or contact shoes to electrically connect the moving rail cars to overhead power lines, also known as conductor bars and/or catenary wires. Due to the relative movement between the pantographs and the overhead power lines, the danger always exists for an obstruction or other fault to lead to substantial damage to the pantograph and/or the overhead power lines. For example, a tree branch or other debris that falls onto the power lines may be caught up in the pantograph and dragged along the power lines for a considerable distance before the problem is detected and the rail car can be stopped. The resulting damage to the pantograph, overhead power lines, passengers, and bystanders may take considerable time and money to repair, during which time transportation over the effected route is no longer possible.

Various protective systems and methods have been developed to reduce damage to the pantograph and/or overhead power lines. For example, each pantograph may include a shear pin designed to readily break in the event that the pantograph comes into contact with excessive resistance on the power lines. Once the shear pin breaks, gravity or other biasing forces may be applied to the pantograph to lower the pantograph away from the overhead power lines. In addition, the pantograph may include manual or automated systems that further lower or retract the pantograph in the event that the shear pin is broken. Although effective at reducing damage to the pantograph and/or power lines, the responsiveness of the protective systems may be too slow to prevent otherwise avoidable damage to the overhead power lines. Therefore, a system and method for lowering a pantograph that can detect a broken shear pin and/or accelerate lowering and/or retracting the pantograph would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for lowering a pantograph. The system includes a frame and first means for retracting the frame. The system further includes second means for increasing a rate at which the first means retracts the frame.

In another embodiment of the present invention, a system for lowering a pantograph includes a frame and means for retracting the frame. The system further includes a continuity circuit operably connected to the means to increase a rate at which the means retracts the frame.

An alternate embodiment within the scope of the present invention also includes a system for lowering a pantograph having a frame, a shear connection in the frame, and a continuity circuit operably connected to the shear connection. A motor is operably connected to the continuity circuit, and the motor actuates to retract the frame when the continuity circuit is broken.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a system for lowering a pantograph in a retracted position;

FIG. 2 is a perspective view of the system shown in FIG. 1 in an extended position;

FIG. 3 is a perspective view of the shear connection shown in FIGS. 1 and 2; and

FIG. 4 is a block diagram of an exemplary control circuit within the scope of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for lowering a pantograph. The pantograph generally includes a frame that may be extended or retracted. The system and method may include various means for retracting the frame and for increasing a rate at which the frame is retracted. In particular embodiments, for example, an electric, pneumatic, or hydraulic motor may be used to retract the frame during normal operations, and a continuity circuit operably connected to the motor may accelerate the rate at which the motor retracts the frame. Although exemplary embodiments will be described in the context of a pantograph connected to a rail car, one of ordinary skill in the art will readily appreciate from the teachings herein that embodiments of the present invention are not limited to use with a rail car unless specifically recited in the claims.

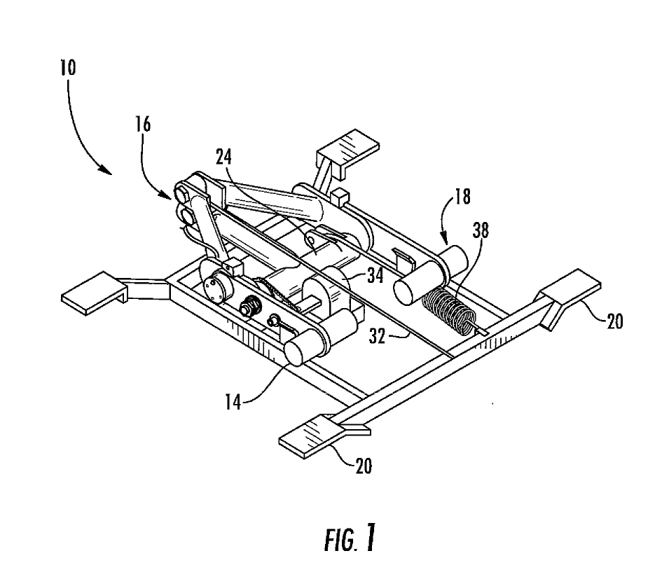

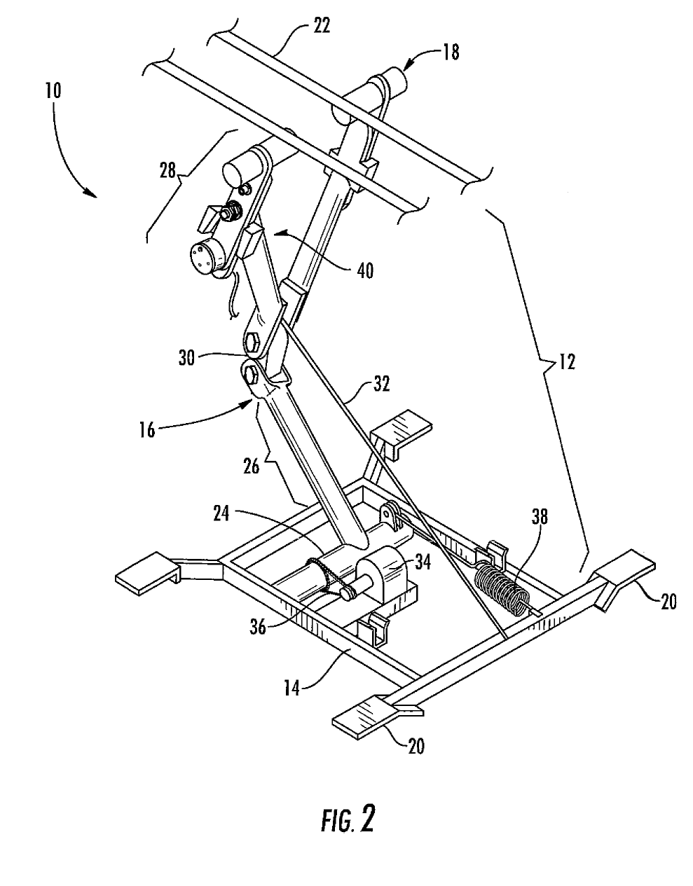

Referring now to the drawings, wherein identical numerals indicate the same elements throughout the figures, FIGS. 1 and 2 provide perspective views of a system 10 for lowering a pantograph 12 in retracted and extended positions, respectively. Various pantograph 12 designs are well known in the art, and the particular type and construction of the pantograph 12 is not a limitation of the present invention unless specifically recited in the claims. As shown in FIGS. 1 and 2, the exemplary pantograph 12 may include a base 14, a frame 16, and a current collector or contact shoe 18. The base 14 may include one or more extensions 20 that provide suitable attachment points for connecting the pantograph 12 to a rail car (not shown) or other moving structure.

The frame 16 may include various structures to allow the frame 16 to alternately extend and retract the current collector 18 with respect to the overhead power lines 22. As shown in FIGS. 1 and 2, for example, the frame 16 may include an axis 24, a lower assembly 26, and an upper assembly 28. The axis 24 may be rotatable with respect to the base 14 and connected to the lower assembly 26. The lower assembly 26 in turn may be connected to the upper assembly 28 by a pivotal connection 30, and a rod 32 may connect the upper assembly 28 to the base 14. Referring to the retracted position shown in FIG. 1, the axis 24 has been rotated counterclockwise to cause the lower assembly 26 to recline horizontally with respect to the base 14. As the lower assembly 26 reclines, the pivotal connection 30 allows the rod 32 to pull the upper assembly 28 downward to similarly recline horizontally with respect to the base 14, thus lowering the current collector 18 away from the overhead power lines 22. Conversely, referring to the extended position shown in FIG. 2, the axis 24 has been rotated clockwise to cause the lower assembly 26 to raise vertically away from the base 14. As the lower assembly 26 raises vertically, the pivotal connection 30 allows the rod 32 to push the upper assembly 28 upward to similarly raise vertically with respect to the base 14, thus raising the current collector 18 toward the overhead power lines 22. In this manner, rotation of the axis 24 with respect to the base 14 articulates the frame 16 to raise or lower the current collector 18 with respect to the overhead power lines 22.

As shown in FIGS. 1 and 2, the pantograph 12 includes various means for extending and retracting the frame 16. The structure for the means may include one or more springs, motors, pistons, or other equivalent devices known in the art for moving or rotating the axis 24. As used herein, a motor or a piston may receive electric, pneumatic, or hydraulic power to operate and move or rotate the axis 24. For example, in the exemplary embodiment shown in FIGS. 1 and 2, the means for retracting the frame 16 may include an electric motor 34 operably connected between the axis 24 and the base 14. To retract the frame 16, as shown in FIG. 1, the motor 34 energizes to drive a chain 36 connected to the axis 24 to rotate the axis 24 counterclockwise, reclining the lower assembly 26 horizontally with respect to the base 14 and causing the rod 32 to pull the upper assembly 28 downward. In alternate embodiments, the motor 34 may be directly coupled to the axis 24. When the frame 16 is fully retracted, a clamp (not shown) or other restraining mechanism may be engaged with the lower and/or upper assembly 26, 28 to hold the frame 16 in the retracted position when the motor 34 is de-energized.

As also shown in the exemplary embodiment shown in FIGS. 1 and 2, the means for extending the frame 16 may include a spring 38 connected in tension between the axis 24 and the base 14. To extend the frame 16, as shown in FIG. 2, the spring 38 retracts to rotate the axis 24 clockwise, raising the lower assembly 26 vertically away from the base 14 and causing the rod 32 to push the upper assembly 28 upward. When the current collector 18 contacts the overhead power lines 22, tension in the spring 38 holds the current collector 18 against the power lines 22 to enhance continuous engagement between the current collector 18 and power lines 22 as the distance between the power lines 22 and the rail car varies along the rail system.

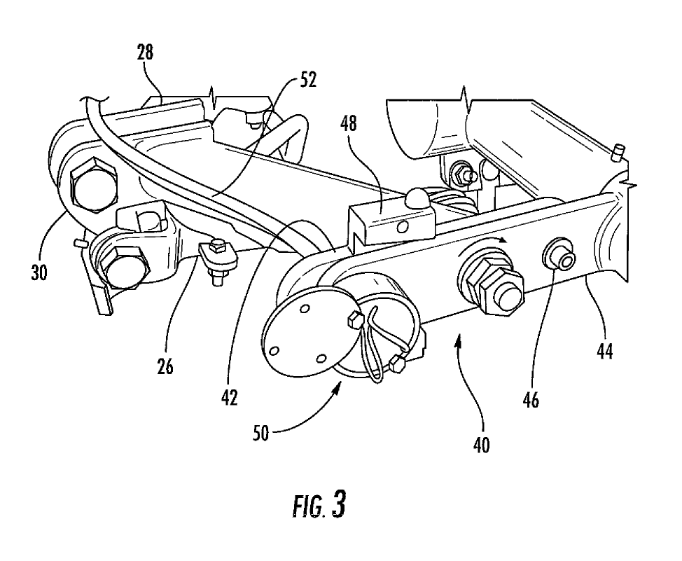

The upper assembly 28 of the frame 16 may include a shear connection 40 or other protective design to reduce damage to the pantograph 12 and/or overhead power lines 22 in the event of an obstruction or other fault between the pantograph 12 and the power lines 22, and FIG. 3 provides a perspective view of the shear connection 40 shown in FIGS. 1 and 2. As shown in FIG. 3, the shear connection 40 may include a first segment 42 pivotally connected to a second segment 44 in the upper assembly 28. A shear pin 46 passes through the first and second segments 42, 44 to prevent the first segment 42 from pivoting with respect to the second segment 44 during normal operations. However, in the event that the pantograph 12 or upper assembly 28 encounters an obstruction or other fault, the shear pin 46 breaks to allow the second segment 44 to pivot with respect to the first segment 42. Gravitational forces may then cause the current collector 18 to drop down and away from the overhead wires 22 to reduce any further contact between the current collector 18 and the obstruction. A mechanical stop 48 or other physical limit on the upper assembly 28 may contact the second segment 44 to prevent the second segment 44, and thus the current collector 18, from dropping all of the way onto the rail car below.

The system 10 may further include means for increasing a rate at which the means retracts the frame 16. The means for increasing the rate at which the means retracts the frame 16 may include, for example, sensors in the upper assembly 28 that detect that the shear pin 46 has broken and transmit a signal to the means for retracting the frame 16 to actuate the means to fully retract the frame 16. In the particular embodiment shown in FIG. 3, the means for increasing the rate at which the means retracts the frame 16 includes a continuity circuit 50, such as a fiber optic cable 52, wire, or other electrical conductor, that passes through the shear connection 40 in the upper assembly 28. As the shear pin 46 breaks, the first segment 42 pivots with respect to the second segment 44 and shears the fiber optic cable 52 to interrupt the continuity circuit 50. The interruption in the continuity circuit 50 in turn triggers a control circuit 60 to actuate and/or increase the rate at which the means retracts the frame 16.

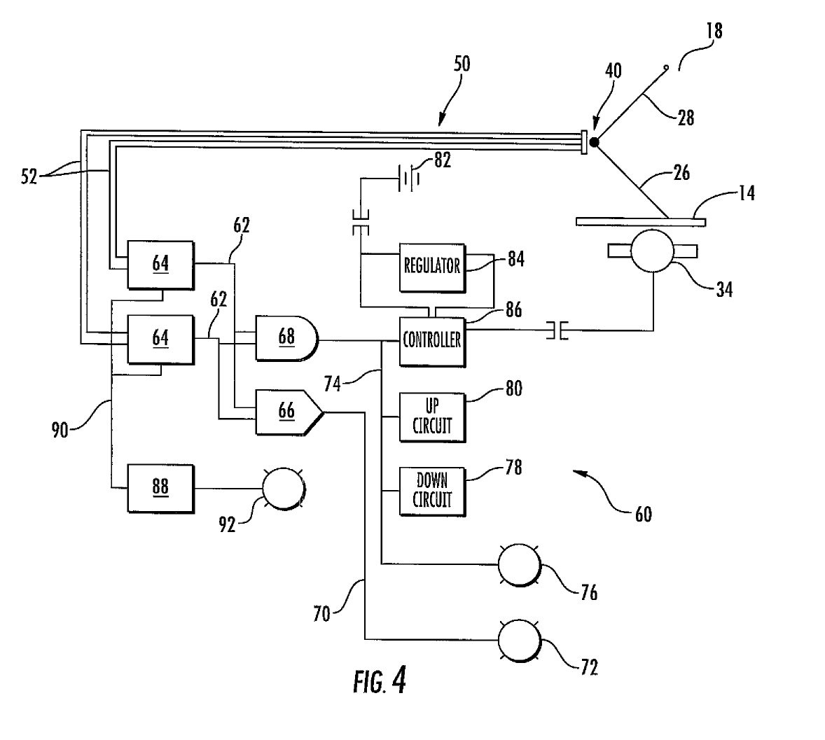

FIG. 4 provides a block diagram of an exemplary control circuit 60 within the scope of the present invention. As shown in FIG. 4, the continuity circuit 50 is operably connected to the control circuit 60 to provide a continuity signal 62 to the control circuit 60. In this particular embodiment, the continuity circuit 50 includes two fiber optic sensors 64 and associated fiber optic cables 52 to provide redundant continuity signals 62 to the control circuit 60 to reduce the incidence of spurious false continuity signals 62. Each continuity signal 62 passes to an OR gate 66 and an AND gate 68. If either or both continuity signals 62 indicate a lack of continuity, the OR gate 66 generates a signal 70 to illuminate a light 72 to indicate that the system 10 requires service.

If both continuity signals 62 indicate a lack of continuity, the AND gate 68 generates a signal 74 to simultaneously perform one or more functions in the control circuit 60. For example, the signal 74 may illuminate a warning light 76 to indicate that the shear pin 46 has broken, that the current collector 18 has dropped away from the overhead lines 22, and/or that the safety system 10 has been actuated and the frame 16 is being automatically retracted. The signal 74 may also actuate the means for retracting the frame 16, represented by block 78, while it simultaneously disables the means for extending the frame 16, indicated by block 80.

The system 10 shown and described herein generally includes a power supply for the means for retracting the frame 16, and the means for increasing the rate at which the means retracts the frame 16 may include a regulator of the power supply. For example, the power supply may provide electricity, pneumatic pressure, or hydraulic pressure to operate the means for retracting the frame 16, and the regulator may alter the voltage, pneumatic pressure, or hydraulic pressure to increase the rate at which the means retracts the frame 16. In the particular embodiment shown in FIG. 4, for example, the means for retracting the frame 16 is an electrical motor 34, the power supply is a battery 82, and the regulator is an electrical power supply regulator 84. The signal 74 may actuate a controller 86 to increase the voltage supplied by the electrical power supply regulator 84 to the motor 34, thus increasing the speed of the motor 34 and the rate at which the motor 34 retracts the frame 16. In this manner, the control circuit 60 operably connects the motor 34 to the continuity circuit 50 to actuate and retract the frame 16 when the continuity circuit 50 is broken.

As shown in FIG. 4, the control circuit 60 may optionally include an override switch 88 that can be selected to send all artificial continuity signal 90 through the fiber optic sensors 64 to the logic gates 66, 68. When selected, the override switch also illuminates a warning light 92 to indicate that the protections provided by the safety system 10 are being overridden. In this manner, the override switch 88 may be used to override and/or periodically test the functions of the safety system 10.

The system 10 shown and described with respect to FIGS. 1-4 may also provide a method for lowering the pantograph 12. The method may include, for example, sensing the condition of the shear connection 40, shear pin 46, and/or continuity circuit 50. If the shear connection 40, shear pin 46, and/or continuity circuit 50 indicates that the pantograph 12 has encountered an obstruction, the method may actuate and/or accelerate the rate at which the means for retracting the frame 16 operates. For example, in particular embodiments, the method may regulate the power supply 82 to the means for retracting the frame 16 and increase the power supply to increase the rate at which the frame 16 is retracted. In still further embodiments, the method may disable the means for extending the frame 16 and/or illuminate various warning lights 72, 76, 92 to indicate the functional status of the system 10.

The various embodiments of the present invention shown in FIGS. 1-4 may provide one or more benefits over existing systems. For example, the system 10 automatically reacts to indications that the pantograph 12 has impacted an obstruction by retracting the pantograph 12 to reduce additional damage to the pantograph 12 and/or overhead power lines 22. In addition, the system 10 may accelerate the rate at which the pantograph 12 is retracted compared to normal retraction rates to further reduce the chance that the obstruction will cause additional damage to the pantograph 12 and/or overhead power lines 22. One of ordinary skill in the art will readily appreciate from the teachings herein that the continuity circuit 50 may be readily retrofitted to existing pantograph 12 designs to provide a reliable indication of the status of the pantograph 12, and the continuity circuit 50 may be easily reset or restored without specialized tools in the event of an accident, thus reducing the need for replacement parts or extensive delays.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for lowering a pantograph, comprising:
a. a frame;
b. first means for retracting the frame; and
c. second means for increasing a rate at which the first means retracts the frame.

2. The system as in claim 1, further comprising a shear connection in the frame that actuates the second means for increasing the rate at which the first means retracts the frame.

3. The system as in claim 1, wherein the first means comprises an electric motor.

4. The system as in claim 1, wherein the second means for increasing the rate at which the first second means retracts the frame comprises an electrical power supply regulator.

5. The system as in claim 1, wherein the second means for increasing the rate at which the first means retracts the frame comprises a continuity circuit.

6. The system as in claim 1, wherein the second means for increasing the rate at which the first means retracts the frame comprises a fiber optic cable.

7. A system for lowering a pantograph, comprising:
a. a frame;
b. means for retracting the frame; and
c. a continuity circuit operably connected to the means to increase a rate at which the means retracts the frame.

8. The system as in claim 7, further comprising a shear connection in the frame, and the continuity circuit passes through the shear connection.

9. The system as in claim 7, wherein the means for retracting the frame comprises an electric motor.

10. The system as in claim 7, further comprising an electrical power supply regulator operably connected between the continuity circuit and the means for retracting the frame.

11. The system as in claim 7, wherein the continuity circuit comprises a fiber optic cable.

12. A system for lowering a pantograph, comprising:
a. a frame;
b. a shear connection in the frame;
c. a continuity circuit operably connected to the shear connection; and
d. a motor operably connected to the continuity circuit, wherein the motor actuates to retract the frame when the continuity circuit is broken.

13. The system as in claim 12, wherein the motor is an electric motor.

14. The system as in claim 12, further comprising an electrical power supply regulator operably connected between the continuity circuit and the motor.

15. The system as in claim 12, wherein the continuity circuit comprises a fiber optic cable.
